(19) United States
(12) Patent Application Publication
(10) Pub. No.: US 2016/0219837 A1
(43) Pub. Date: Aug. 4, 2016

(54) Compression Pet Collar Clasp

(71) Applicant: Mark Lee Cosgrove, Amarillo, TX (US)

(72) Inventor: Mark Lee Cosgrove, Amarillo, TX (US)

(21) Appl. No.: 14/613,332

(22) Filed: Feb. 3, 2015

(51) Int. Cl. A01K 27/00; A44B 13/02

(52) U.S. Cl. CPC A01K 27/005; A44B 13/02

(57) ABSTRACT

A compression pet collar clasp is a device, thin and elongated in shape, whose purpose is to provide a releasable attachment to an animal collar. A leash, rope, etc . . . is fixed securely to one end, the opposing end has a pivoting latch member that is moveable between a closed and opened position. The closed position is maintained by a compress spring, supported by a stationary base member, exerting upward resistance on the latch member. Opening and thereby allowing animal collar attaching or disengaging is accomplished by applying downward pressure on the latch member with a thumb or finger. The stationary base member, compress spring, latch member and latch member pivot pin are encased within a pair of decorative handles.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF THE INVENTION

The present invention relates to quick connect/disconnect clasp between a leash and an animal, specifically a dog, collar. Typically leashes connect to collars by incorporating some form of clasp which requires sliding a lever or manipulating a thumb tab. This can be difficult for dog owners in general but especially true for those with physical ailments, such as arthritis. Even owners of frisky or overly excited dogs can experience difficulty. The present invention addresses these difficulties by providing a device which eliminates the short comings of prior art devices.

### BRIEF SUMMARY OF THE INVENTION

The invention, a compression pet collar clasp, is a device, thin and elongated in shape, simple in design and in operation. The invention allows quick and easy attachment (and obvious detachment) of a leash, rope, etc . . . , to an animal collar, specifically a dog collar. The invention is easily operated with one hand and requires no fumbling with a sliding bolt or protruding tab member as found on prior art clasps. The leash, rope, etc . . . is attached to one end of the invention and the opposing end provides the releasable engagement to the dog collar o-ring. The position of a pivoting latch member determines if the end opposite the leash is in either a closed or opened state. Resistance from a compress spring keeps the latch member in the “closed” state; opening is accomplished by applying downward pressure, with a thumb or finger, on the latch member/compress spring.

### BRIEF DESCRIPTION OF THE SEVERAL VIEWS OF THE DRAWING

The drawings constitute a part of this specification and include exemplary embodiments to the invention, which may be embodied in various forms.

FIG. 1 is a perspective view of the compression pet collar clasp in a normally closed position in accordance with principle of the present invention.

FIG. 2 is a perspective view similar to FIG. 1 but illustrating the location of the internal components.

FIG. 3 is a view similar to FIG. 1 but with outside handles removed revealing the internal components.

FIG. 4 is a perspective view of the compression pet collar clasp, in an open position, in accordance with principle of the present invention.

FIG. 5 is a perspective similar to FIG. 4 but illustrating the location of the internal components.

FIG. 6 is a view similar to FIG. 4 but with outside handles removed revealing the internal components and also illustrating the spring compression when in the open position.

FIG. 7 is an exploded view of the compression pet collar clasp, in accordance with principle of the present invention.

FIG. 8 is a perspective view of the compression pet collar clasp connected to an o-ring which in turn could be attached to a pet collar or harness and the opposing end attached to a rope, strap, leash, etc.

### DETAILED DESCRIPTION OF THE INVENTION

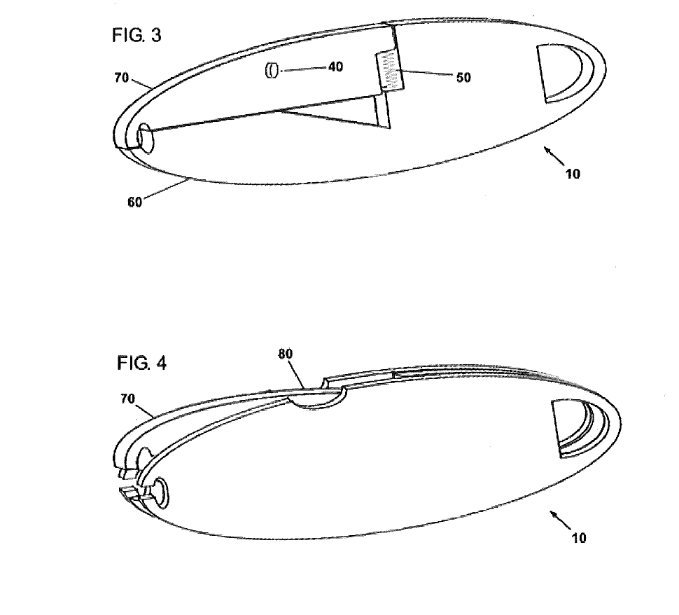

Following is a detailed description and explanation of the compression pet collar clasp embodiments, referred to herein as the “clasp”. Also, FIG. 3 and FIG. 6 omit certain components to better illustrate the invention.

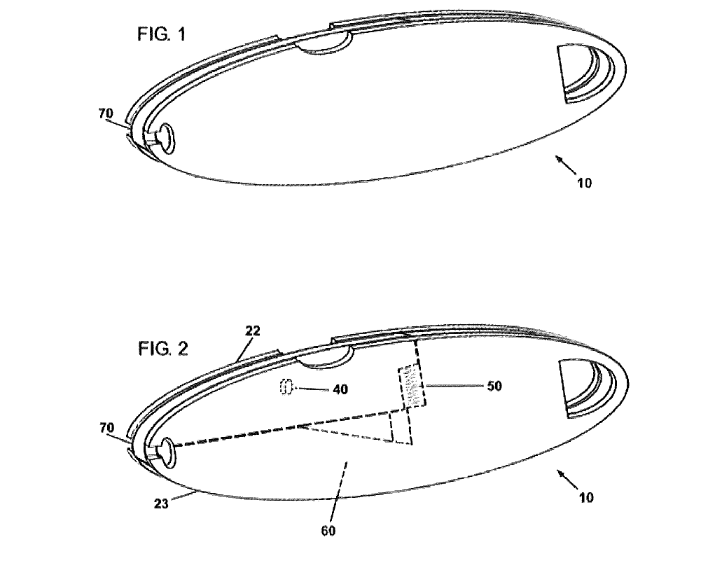

FIG. 1 is a perspective view showing the clasp 10 with the latch member 70 in the closed position.

FIG. 2 is similar to FIG. 1, however it illustrates a pin 40 inserted through and supporting the latch member 70. Pin 40 is supported by the handles 22 and 23. Latch member 70 is held in the closed position from resistance provided by compress spring 50 which is supported by base member 60. Base member 60 is held in place by securing between handles 22 and 23 using epoxy adhesive.

FIG. 3 shows the clasp 10 with the latch member 70 in the closed position, however the outside handles have been removed to better illustrate a pin 40 inserted through and supporting the latch member 70. Latch member 70 is held in the closed position from upward resistance provided by compress spring 50 which is supported by base member 60.

FIG. 4 is a perspective view showing the clasp 10 with the latch member 70 in the open position. Opening the clasp latch member 70 is accomplished by pressure being applied, by a handler's thumb or finger, at point 80.

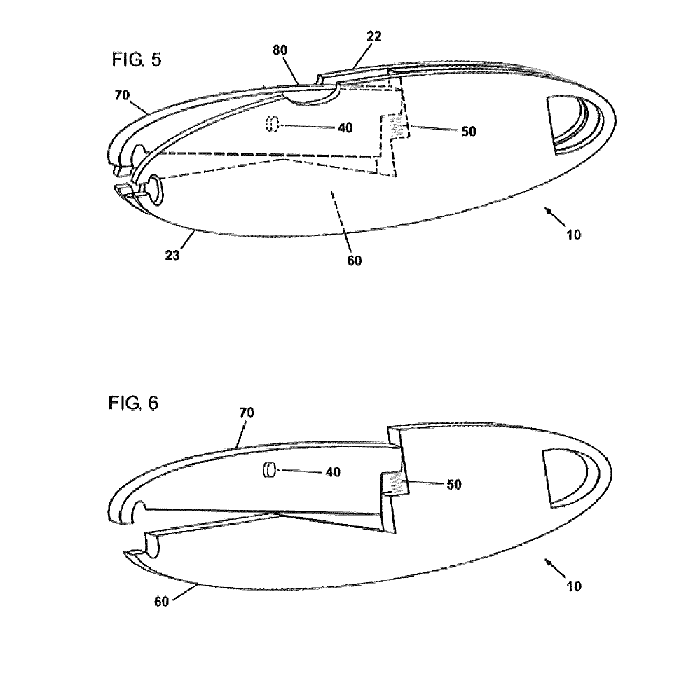

FIG. 5 is similar to FIG. 4, however it illustrates a pin 40 inserted through and supporting the latch member 70. Pin 40 is supported by each of the handles 22 and 23. Latch member 70 is held in the open position from downward pressure being applied to point 80 which results in the compression of spring 50 which is supported by base member 60. Base member 60 is held in place by securing between handles 22 and 23 using epoxy adhesive.

FIG. 6 shows the clasp 10 with the latch member 70 in the open position, however the outside handles have been removed to better illustrate a pin 40 inserted through and supporting the latch member 70. Latch member 70 is held in the open position from downward pressure being applied to point 80 which results in the compression of spring 50 which is supported by base member 60.

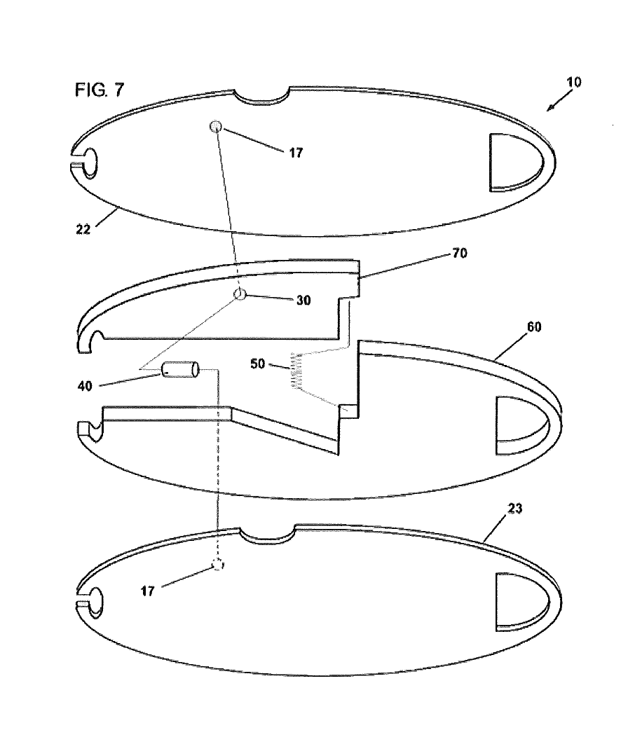

FIG. 7 illustrates the clasp 10 in an exploded view which includes two opposing handles, an inside perspective view of the backside handle 22 and an outside perspective view of the front handle 23, each handle has a countersunk hole 17 providing support for pin 40; an latch member 70, with pin through-hole 30, which pivots on pin 40 and base member 60 which provides support for compress spring 50.

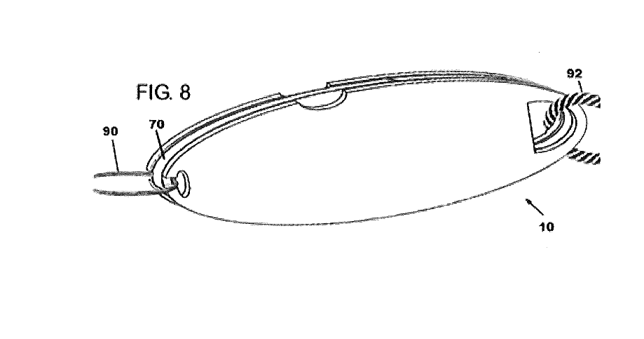

FIG. 8 is a perspective view of clasp 10, similar to FIG. 1. The left side of view illustrates the clasp closed around an o-ring 90 which in turn could be attached to a pet collar, harness or similar device and the opposing clasp end secured to a leash or rope 92.

1. A pet collar clasp, elongated in shape, which can be easily held and operated with one hand, wherein to one end attaches a leash, rope, etc . . . and the opposing end, which is in either an open or closed state, to which a pet collar is engaged or disengaged.

2. The device defined in claim 1, comprising a latch member pivoting on a stationary pin, a compress spring and a fixed base member.

3. The device defined in claim 2, wherein the four members are sandwiched (held in place) between two solid pieces of material; i.e.: handles.

4. The device defined in claim 2, additionally resistance from a compress spring, supported by the base member, keeps the latch member in the closed position.

5. The device defined in claim 4, additionally the latch member is opened by applying downward pressure with a thumb or finger, thereby allowing pet collar engagement or release.
